(19) United States
(12) Patent Application Publication
(10) Pub. No.: US 2020/0369848 A1
(43) Pub. Date: Nov. 26, 2020

(54) Fiber-Reinforced Polymeric Compositions

(71) Applicants: Mark Moskowitz, Los Angeles, CA (US); Catalin Tutunaru, Scarborough, ME (US)

(72) Inventors: Mark Moskowitz, Los Angeles, CA (US); Catalin Tutunaru, Scarborough, ME (US)

(21) Appl. No.: 16/879,550

(22) Filed: May 20, 2020

Related U.S. Application Data
(60) Provisional application No. 62/850,960, filed on May 21, 2019.

(51) Int. Cl. C08J 9/35; B32B 7/12; B32B 5/18; C08J 5/04

(52) U.S. Cl. CPC C08J 9/35; B32B 7/12; B32B 5/18; C08J 5/042; C08J 2205/06; C08J 2363/00; C08J 2375/04; C08J 2205/10; C08J 2205/08; B32B 2266/0278

(57) ABSTRACT

In one aspect, a fiber-reinforced polymer is disclosed, which comprises a resin, and a plurality of carbon fiber filaments distributed throughout the resin, where at least about 60 percent of the carbon filaments are substantially aligned relative to one another. In some embodiments, at least about 70 percent, or at least about 80 percent, or at least about 90 percent, of the carbon filaments are substantially aligned relative to one another.

### RELATED APPLICATION

The present application claims priority to a Provisional Patent Application No. 62/850,960 titled “Fiber-Reinforced Polymeric Compositions,” filed on May 21, 2019, which is herein incorporated by reference in its entirety.

### BACKGROUND

The present disclosure relates generally to fiber-reinforced polymeric compositions and composite materials that can be fabricated using such fiber-reinforced polymeric compositions.

Polymeric materials are used in a variety of applications. Despite the ubiquity of polymeric materials, there is still a need for enhanced polymeric compositions that can be employed for fabricating a variety of applications. For example, there is a need for polymeric compositions with enhanced energy-absorbing properties. For example, in a variety of sports, there is a need for polymeric compositions that can provide enhanced absorption of energy due to impact while militating against damage to the athlete.

### SUMMARY

In one aspect, a fiber-reinforced polymer is disclosed, which comprises a resin, and a plurality of carbon fiber filaments distributed throughout the resin, where at least about 60 percent of the carbon filaments are substantially aligned relative to one another. In some embodiments, at least about 70 percent, or at least about 80 percent, or at least about 90 percent, of the carbon filaments are substantially aligned relative to one another.

In some embodiments, the resin can be an epoxy laminating resin. A suitable example of an epoxy laminating resin includes, without limitation, a molded epoxy system that is manufactured by Miller-Stephenson Chemical Co. of Danbury, Conn. under the trade name EPON™, and which is described in more detail below. In some embodiments, the resin can include a rubberizing compound, such as polymethylsiloxane (PDMS).

In some embodiments, the weight concentration of the carbon fiber filaments in any of the rubberizing compound or epoxy laminating resin is in a range about 30% to about 40%, e.g., 35%. In some embodiments, the weight concentration of the rubberizing compound or the epoxy laminating resin in a fiber-reinforced polymer is in a range of about 50% to about 70%.

In some embodiments, the fiber-reinforced polymer exhibits a hardness of at least about 3 Shore, e.g., in a range of about 3 to about 6.5 Shore.

In a related aspect, a method of forming a fiber-reinforced polymer is disclosed, which comprises heating a resin to a melting temperature thereof, and dispersing a plurality of carbon fiber filaments within the resin such that at least about 70%, and preferably at least about 80%, and preferably at least about 90%, of the fibers are substantially aligned relative to one another. As discussed in more detail below, in some embodiments, Directed Carbon Fiber Preform (DCFP) methods and systems can be employed to achieve alignment of the carbon fibers within the polymer. In some cases, the DCFP method can be used to achieve alignment of 95% of the carbon fibers, e.g., within 1 to 10 degrees.

In another aspect, a composite material is disclosed, which comprises a first viscoelastic foamed layer having a hard firmness, and a second viscoelastic foamed layer disposed adjacent the first viscoelastic foamed layer, where the second viscoelastic foamed layer has a medium firmness. In some embodiments, the hard firmness viscoelastic foamed layer exhibits a density in a range of about 0.5 pounds per cubic foot to about 5 pounds per cubic foot, e.g., in a range of about 1 pound per cubic foot to about 4 pounds per cubic foot, or in a range of about 2 to about 3 pounds per cubic foot, or in a range of about 1.2 pounds per cubic foot to about 1.3 pounds per cubic foot. In some embodiments, the medium firmness viscoelastic foamed layer exhibits a density in a range of about 0.25 pounds per cubic foot to about 15 pounds per cubic foot.

In some embodiments, the composite material further includes a third viscoelastic foamed layer having a soft firmness, where the third viscoelastic foamed layer is disposed adjacent the second viscoelastic foamed layer. In some embodiments, the soft firmness viscoelastic foamed layer exhibits a density in a range of about 0.85 psi/sq. ft. to about 0.95 psi/sq. ft.

In some embodiments, at least one of the viscoelastic foamed layers can include a fiber-reinforced polymer as disclosed herein, where the polymer has been foamed, e.g., via injection of nitrogen into the polymer.

In some embodiments, the hard firmness layer exhibits a firmness in a range of about 1.14 psi/sq. ft. to about 1.22 psi/sq. ft., the medium firmness viscoelastic foamed layer exhibits a firmness in a range of about 0.85 psi/sq. ft. to about 0.95 psi/sq. ft., and the soft firmness viscoelastic foamed layer exhibits a firmness in a range of about 0.65 psi/sq. ft. to about 0.73 psi/sq. ft.

In some embodiments, the hard firmness viscoelastic foamed layer comprises a plurality of pores at a pore concentration in a range of about 600 pores per cubic inch to about 1,100 pores per cubic inch, e.g., in a range of about 800 pores per cubic inch to about 900 pores per cubic inch. Further, in some embodiments, the second viscoelastic foamed layer comprises a plurality of pores at a pore concentration in a range of about 860 pores per cubic inch to about 1,360 pores per cubic inch, e.g., in a range of about 1060 pores per cubic inch to about 1,160 pores per cubic inch. In some embodiments, the soft firmness viscoelastic foamed layer comprises a plurality of pores at a pore concentration in a range of about 880 pores per cubic inch to about 1,380 pores per cubic inch, e.g., in a range of about 1,080 pores per cubic inch to about 1,180 pores per cubic inch. In some embodiments, the void fraction of a foamed layer (i.e., the ratio of volume of the pores to the total volume of the layer) can be, for example, in a range of about 20% to about 50%, e.g., in a range of about 10% to about 30%.

In some embodiments, any of the first, the second, and the third viscoelastic foamed layer comprises any of viscoelastic polyurethane foam, a low-resilience polyurethane foam, a memory foam and combinations thereof.

A composite material according to the present teachings can include the above three hard firmness, medium firmness, and soft firmness viscoelastic layers with any combination of the firmness values disclosed herein. Further, while in some embodiments, the medium firmness layer is sandwiched between the hard and the soft firmness layers, in other embodiments, the order of the layers in the composite material can be different.

In a related aspect, a method of fabricating a composite is disclosed, which comprises infusing a gas into a viscoelastic material to generate a plurality of pores therein, and adjusting the gas infusion so as to obtain a hard firmness foamed material, and utilizing the viscoelastic foamed material to generate a viscoelastic foamed layer, which exhibits a hard firmness. The method can further include infusing a gas into a viscoelastic material to generate a plurality of pores therein, and adjusting the gas infusion so as to obtain a medium firmness foamed material. The medium firmness foamed material can be utilized to generate another viscoelastic foamed layer, which exhibits a medium firmness.

The hard firmness viscoelastic layer can be attached to the medium firmness viscoelastic layer to form a composite material. By way of example, in some embodiments, the various layers of a composite material according to the present teachings can be joined via an adhesive compound.

In some embodiments, the method can further include generating a soft firmness viscoelastic layer by infusing a gas into a viscoelastic material to generate a plurality of pores therein, and adjusting the gas infusion so as to obtain a soft firmness foamed material. The soft firmness foamed material can be utilized to form a soft firmness viscoelastic layer.

In some embodiments, the layers of the composite can be formed by forming a flexible epoxy matrix. By way of example, in some embodiments, the flexible epoxy matrix can be formed of PDMS (polydimethylsiloxane). Subsequently, nitrogen can be infused into the composition at a desired ratio to increase or decrease the plasticity of the flexible epoxy matrix. In some embodiments, at least one layer of the composite can include a flexible epoxy matrix in which nanoparticles of silica and/or rubber have been distributed.

In some embodiments, the hard firmness, the medium firmness and the soft firmness viscoelastic layers can be attached to one another to form a composite material. In other embodiments, the two foamed layers can be formed of different viscoelastic materials.

As noted above, in some embodiments, the gas employed for forming the above viscoelastic foamed layers can be nitrogen.

In some embodiments, the same viscoelastic material can be employed to form the hard firmness and the medium firmness viscoelastic foamed layers. In other embodiments, at least two of the viscoelastic layers can be formed of different materials.

In some embodiments, in the above method, the viscoelastic material can be, without limitation, any of viscoelastic polyurethane, low-resilience polyurethane, memory foam and combinations thereof.

Further understanding of various aspects of the present teachings can be obtained by reference to the following detailed description in conjunction with the associated drawings, which are described briefly below.

### BRIEF DESCRIPTION OF THE DRAWINGS

FIG. 1 schematically depicts a fiber-reinforced polymeric composition according to an embodiment of the present teachings,

FIG. 2 schematically depicts a composite material according to an embodiment of the present teachings,

FIG. 3 is a flow chart depicting various procedures in a method for fabricating a composite material according to an embodiment of the present teachings,

FIG. 4 schematically depicts a composite material according to an embodiment of the present teachings, which includes two adjacent layers exhibiting different degrees of firmness,

FIG. 5 schematically depicts a composite material according to another embodiment of the present teachings, which includes three polymeric layers exhibiting different degrees of firmness, and

FIG. 6 is flow chart depicting various steps for forming a composite material according to an embodiment of the present teachings.

### DETAILED DESCRIPTION

The present teachings are directed to fiber-reinforced polymeric compositions as well as composite materials that include multiple layers of viscoelastic materials exhibiting different firmness. As discussed below, such composite materials can be employed in a variety of applications, including sport equipment.

Various terms are used herein according to their ordinary meanings in the art. The phrase “substantially aligned” as used herein to describe the relative orientations of the carbon fiber filaments means that the deviations of the carbon fiber filaments from perfect parallelism is less than 10 degrees and preferably less than 5 degrees.

The term “about” as used herein indicates a maximum deviation of less than 5% around a numerical value.

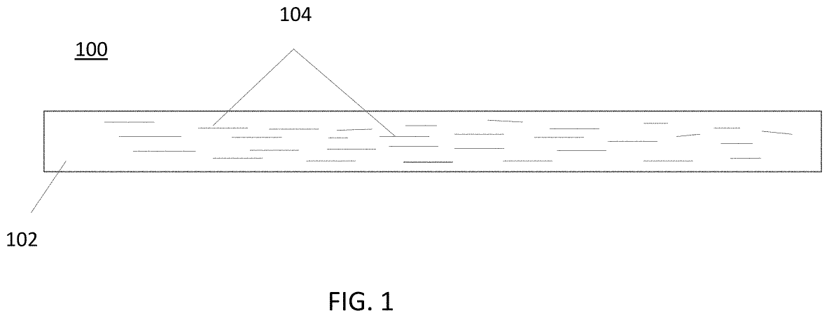

FIG. 1 schematically depicts a fiber-reinforced polymer 100 that includes a resin 102 in which a plurality of carbon fiber filaments 104 are distributed. In this embodiment, the carbon fiber filaments 104 are distributed within the resin 102 such that at least about 60%, or at least about 70%, or at least about 80%, or at least about 90%, of the carbon fiber filaments are substantially aligned relative to one another.

In this embodiment, the fiber-reinforced polymer 100 is in the form of a sheet, though in other embodiments it can have other forms, e.g., it can be molded into any desired shape. In this embodiment, the sheet can have a thickness, for example, in a range of about 2 mm to about 5 mm, a length in a range of about 1 mm to about 20 mm and a width in a range of about 20 mm to about 50 mm.

A variety of resins can be employed for fabricating the fiber-reinforced polymer 100. By way of example, in some embodiments, the resin can be epoxy laminating resin, a rubberizing compound, etc. Some examples of suitable rubberizing compounds include, without limitation, a silicone polymer. For example, the silicone polymer can be PDMS, such as a high molecular weight PDMS. As is known in the art, PDMS can be formed by hydrolyzing Me₂SiCl₂, which can be produced from high-purity SiO₂ and CH₂Cl₂ via the Muller-Rochow reaction.

As noted above, an example of an epoxy laminating resin suitable for use in the practice of the invention can include Diglycidyl Ether of Bisphenol F. Such a resin is commercially available under the trade name EPON™ 862 from Miller-Stephenson. In some embodiments, the EPON™ 862 resin can be employed as the sole epoxy resin while in other embodiments, such a resin can be combined with other resins, such as a resin marketed by Miller-Stephenson Chemical Co. under the tradename EPON™ resin 828. In some embodiments, EPON™ 862 resin can be mixed with a hardener, such as DETDA (Diethyltoluenediamine).

In some embodiments, the weight concentration of the resin in the fiber-reinforced polymer 100 can be, for example, in a range of about 50% to about 90%. Further, in some embodiments, the weight concentration of the carbon fiber filaments that are distributed in the resin can be, for example, in a range of about 10% to about 50%.

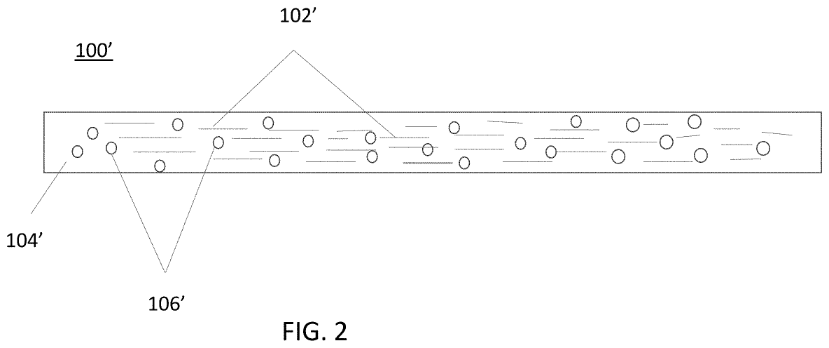

In some embodiments, the fiber-reinforced polymer 100 can be foamed. By way of example, FIG. 2 schematically depicts a fiber-reinforced polymer 100′ that includes a plurality of carbon fiber filaments 102′ that are distributed within a resin 104′ such that at least about 60%, or at least about 70%, or at least about 80%, of the carbon fiber filaments are substantially aligned relative to one another. In this embodiment, the resin 104′ is foamed in that it includes a plurality of small cavities 106′ (herein also referred to as pores) that are distributed throughout the resin. In some embodiments, the concentration of the pores 106′ can be adjusted to obtain a desired weight density of the foamed fiber-reinforced polymer. By way of example, the density of the foamed fiber-reinforced polymer can be, for example, in a range of about 60 pounds per cubic feet to about 1/10^{th} pounds per cubic feet, e.g., in a range of about 50 pounds per cubic feet to about 10 pounds per cubic feet, or in a range of about 40 pounds per cubic feet to about 20 pounds per cubic feet. Further, in some embodiments, the void fraction of the foamed polymer can be in a range of about 20% to about 50%, e.g., in a range of about 10% to about 40%.

Further, in some embodiments, at least one linear dimension of the pores (e.g., the diameter of the pores when the pores are substantially spherical) can be in a range of about 1 mm to 5 mm, e.g., in a range of about 2 mm to about 4 mm.

Similar to the previous embodiment, the resin 104′ can be a rubberizing compound and/or an epoxy laminating resin, such as those listed above.

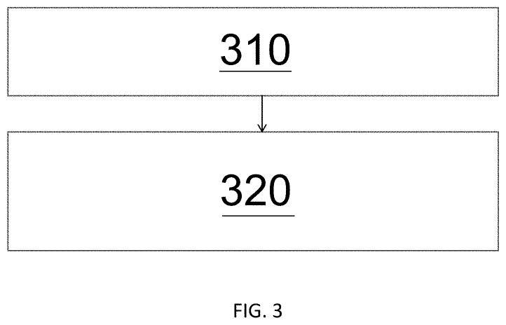

With reference to the flow chart of FIG. 3, in some embodiments, a method for forming a fiber-reinforced polymer can includes heating a resin to a melting temperature thereof (box 310), and dispersing a plurality of carbon fiber filaments within the resin such that at least about 60%, or at least about 70%, or at least about 80%, of the fibers are substantially aligned relative to one another (box 320).

By way of example, in some embodiments, Directed Carbon Fiber Preform (DCFP) methods and systems can be employed to achieve alignment of the carbon fibers within the resin. By way of example, a DCFP system can include a robot-mounted mechanical chopper head, which can spray carbon fibers and a polymeric resin onto a shaped perforated tool. Positive airflow through the tool can hold the deposited fibers in place. Upon completion of the spray deposition process, a matched perforated tool is lowered to compress the preform in order to control the thickness. Hot air is cycled through the perforations to consolidate the resin and subsequently ambient air is cycled to stabilize the preform. Further details regarding DCFP methods and systems can be found, e.g., in an article entitled “Automated Preform Manufacture for Affordable Lightweight Body Structure,” published in 26^{th} International SAMPE Europe Conference, Paris, France, which is herein incorporated by reference in its entirety.

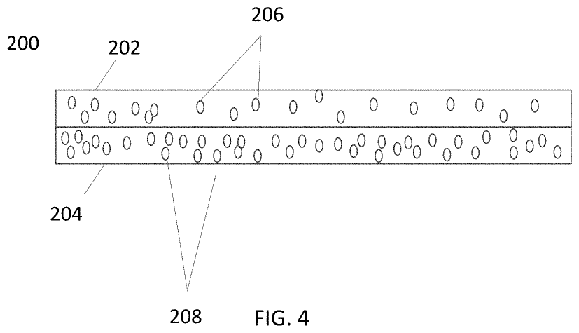

With reference to FIG. 4, in another aspect, a viscoelastic composite material 200 is disclosed, which includes two adjacent viscoelastic foamed layers 202 and 204, where the foamed layer 202 can exhibit a hard firmness and the foamed layer 204 can exhibit a medium firmness. For example, in some such embodiments, the foamed layer 202 can exhibit a firmness in a range of about 1.14 psi/sq. ft. to about 1.22 psi/sq. ft., and the medium firmness layer 204 can exhibit a firmness in a range of about 0.85 psi/sq. ft. to about 0.95 psi/sq. ft. In some embodiments, the adjacent viscoelastic foamed layers 202 and 204 can be attached to one another, e.g., via an adhesive or other suitable mechanisms.

In some embodiments of the above viscoelastic composite material, the foamed layer 202, which exhibits a hard firmness, can have a density in a range of about 0.5 pounds per cubic foot to about 5 pounds per cubic foot, e.g., in a range of about 2 to about 3 pounds per cubic foot. In some such embodiments, the medium firmness viscoelastic foamed layer exhibits a density in a range of about 0.25 pounds per cubic foot to about 15 pounds per cubic foot.

With continued reference to FIG. 4, the viscoelastic layer 202 includes a plurality of pores 206 distributed therein. Similarly, the viscoelastic layer 204 includes a plurality of pores 208 distributed therein. In some embodiments, the concentration of the pores in the viscoelastic layer 202 can be in a range of about 600 pores per cubic inch to about 1,100 pores per cubic inch. Further, in some embodiments, the concentration of the pores in the viscoelastic layer 204 can be in a range of about 860 pores per cubic inch to about 1,360 pores per cubic inch.

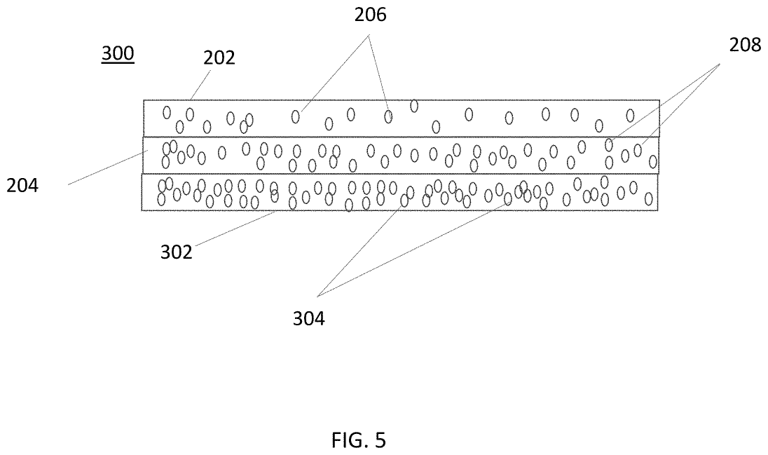

With reference to FIG. 5, in another embodiment, a viscoelastic composite material 300 according to the present teachings can include, in addition to the viscoelastic layers 202 and 204, a third viscoelastic layer 302, which exhibits a soft firmness and is positioned adjacent the viscoelastic layer 204, which exhibits a medium firmness. In some embodiments, the third viscoelastic layer 302 can be attached to the viscoelastic layer 204, e.g., via glue or other suitable mechanisms.

In some such embodiments, the third viscoelastic layer 302 can exhibit a density in a range of about 0.85 psi/sq. ft. to about 0.95 psi/sq. ft. Further, in some embodiments, the third viscoelastic layer 302 can exhibit a firmness in a range of about 0.65 psi/sq. ft. to about 0.73 psi/sq. ft.

Similar to the previous embodiment, the third viscoelastic layer 302 includes a plurality of pores 304 distributed therein. In some embodiments, the concentration of the pores distributed within the viscoelastic layer 302 can be, for example, in a range of about 880 pores per cubic inch to about 1,380 pores per cubic inch.

The dimensions of a composite material according to the present teachings can be selected based on a particular application for which the composite material is intended. By way of example, in some embodiments, each of the viscoelastic foamed layers 202, 204 and 302 can have a thickness in a range of about 5 mm to about 20 mm, though other thicknesses can also be employed.

In some applications, a composite material according to the present teachings can be used as a protective layer in sport equipment for energy absorption. For example, a composite material according to the present teachings can be used in a variety of equipment employed in a variety of sports, e.g., impact sports. For example, a composite material according to the present teachings can be used, e.g., in a football or a soccer helmet. In other embodiments, the composite materials according to the present teachings can be used to protect joints.

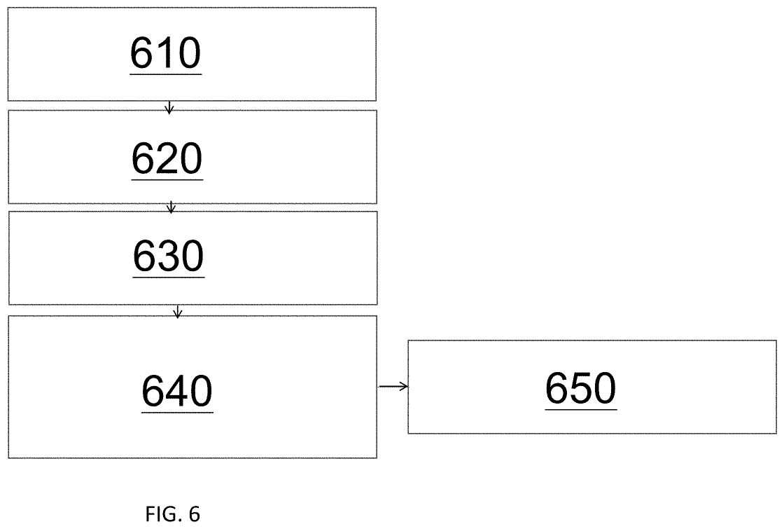

With reference to the flow chart of FIG. 6, a method according to the present teachings for fabricating a composite material includes infusing a gas 610 into a first viscoelastic material to generate a plurality of pores therein, adjusting the gas infusion 620 so as to obtain a desired firmness of the first viscoelastic material, infusing a gas 630 into a second viscoelastic material to generate a plurality of pores therein, adjusting the gas infusion 640 so as to obtain a desired degree of firmness of the second viscoelastic material, where the second firmness is different than the first firmness. The two foamed viscoelastic materials can be attached 650, e.g., via adhesive or other mechanisms, to form a composite material. While in some embodiments, the same viscoelastic material can be employed for forming both of the viscoelastic materials, in other embodiments, different viscoelastic materials can be used. Further, in some embodiments, the above method can be employed for fabricating composite materials having more than two viscoelastic materials.

Those having ordinary skill in the art will appreciate that various changes can be made to the above embodiments without departing from the scope of the present teachings.

1. A fiber-reinforced polymer, comprising:
a resin,
a plurality of carbon fiber filaments distributed throughout the resin,
wherein at least about 60 percent of the carbon filaments are substantially aligned relative to one another.

2. The polymer of claim 1, wherein at least about 70 percent of the carbon fiber filaments are substantially aligned relative to one another.

3. The polymer of claim 1, wherein at least about 80 percent of the carbon fiber filaments are substantially aligned relative to one another.

4. The polymer of claim 1, wherein at least about 90 percent of the carbon fiber filaments are substantially aligned relative to one another.

5. The polymer of claim 1, wherein said resin comprises a rubberizing compound.

6. The polymer of claim 1, wherein said resin comprises an epoxy laminating resin.

7. The polymer of claim 6, wherein said epoxy laminating resin comprises about 30% to about 35% by weight of said fiber reinforced polymer.

8. The polymer of claim 6, wherein said epoxy laminating resin comprises at least about 40% by weight of said fiber reinforced polymer.

9. The polymer of claim 5, wherein said rubberizing compound comprises at least about 50% to about 70% by weight of said fiber reinforced polymer.

10. The polymer of claim 1, wherein said fiber reinforced polymer exhibits a hardness in a range of about 3 Shore to about 6.5 Shore.

11. A composite, comprising
a first viscoelastic foamed layer having a hard firmness, and
a second viscoelastic foamed layer having a medium firmness disposed adjacent said first viscoelastic foamed layer.

12. The composite of claim 11, further comprising a third viscoelastic foamed layer having a soft firmness and positioned adjacent said second viscoelastic foamed layer.

13. The composite of claim 11, wherein said hard firmness viscoelastic foamed layer exhibits a density in a range of about 0.5 pounds per cubic foot to about 5 pounds per cubic foot.

14. The composite of claim 11, wherein said hard firmness viscoelastic foamed layer exhibits a density in a range of about 1.2 pounds per cubic foot to about 1.3 pounds per cubic foot.

15. The composite of claim 11, wherein said hard firmness viscoelastic foamed layer exhibits a firmness in a range of about 1.14 psi/sq.ft to about 1.22 psi/sq.ft.

16. The composite of claim 11, wherein said medium firmness viscoelastic foamed layer exhibits a density in a range of about 0.25 pounds per cubic foot to about 15 pounds per cubic foot.

17. The composite of claim 12, wherein said medium firmness viscoelastic foamed layer exhibits a firmness in a range of about 0.85 psi/sq-ft to about 0.95 psi/sq-ft.

18. The composite of claim 12, wherein said soft firmness viscoelastic foamed layer exhibits a density in a range of about 0.85 psi/sq.ft to about 0.95 psi/sq-ft.

19. The composite of claim 12, wherein said soft firmness viscoelastic foamed layer exhibits a firmness in a range of about 0.65 psi/sq.ft to about 0.73 psi/sq-ft.

20. The composite of claim 11, wherein said first viscoelastic foamed layer comprises a plurality of pores at a pore concentration in a range of about 600 pores per cubic inch to about 1,100 pores per cubic inch.

21. The composite of claim 20, wherein said pore concentration is in a range of about 800 pores per cubic inch to about 900 pores per cubic inch.

22. The composite of claim 11, wherein said second viscoelastic foamed layer comprises a plurality of pores at a pore concentration in a range of about 860 pores per cubic inch to about 1,360 pores per cubic inch.

23. The composite of claim 22, wherein said pore concentration is in a range of about 1,060 pores per cubic inch to about 1,160 pores per cubic inch.

24. The composite of claim 12, wherein said third viscoelastic foamed layer comprises a plurality of pores at a pore concentration in a range of about 880 pore per cubic inch to about 1,380 pores per cubic inch.

25. The composite of claim 24, wherein said pore concentration is in a range of about 1,080 pores per cubic inch to about 1,180 pores per cubic inch.

26. The composite of claim 11, wherein at least one of said first and second viscoelastic foamed layer comprises any of viscoelastic polyurethane foam, a low-resilience polyurethane foam, and a memory foam.

27. The composite of claim 12, wherein any of said first, second, and third viscoelastic foamed layer exhibits a void fraction in a range of about 20% to about 50%.

28-36. (canceled)
